(19) United States
(12) Patent Application Publication
(10) Pub. No.: US 2023/0291776 A1
(43) Pub. Date: Sep. 14, 2023

(54) GROUP VISUALIZATIONS IN ONLINE MEETINGS

(71) Applicant: Microsoft Technology Licensing, LLC, Redmond, WA (US)

(72) Inventors: Defne AYANOGLU, Redmond, WA (US); Nakul MADAAN, Prague (CZ)

(21) Appl. No.: 17/694,016

(22) Filed: Mar. 14, 2022

(51) Int. Cl. H04L 65/403; G06F 3/04817; G06F 3/0486; G06F 3/16

(52) U.S. Cl. CPC H04L 65/403; G06F 3/04817; G06F 3/0486; G06F 3/165; G06F 3/0482

(57) ABSTRACT

Systems and methods may be used for coordinating users into groups in an online meeting. A method may include, during a video conferencing meeting, displaying, in a participant user interface component, attendee video streams of attendees of the video conferencing meeting, identifying tags for the attendees of the video conferencing meeting, and determining, from content shared within the video conferencing meeting, metadata corresponding to at least one tag of the tags for the attendees. The method may include, responsive to determining the metadata: generating a group of attendees that are associated with the tag, selecting a subset of the attendee video streams based on the group of attendees, and dynamically recomposing the participant user interface component to include the subset of the attendee video streams.

### BACKGROUND

Current online conferencing solutions in the market allow participants who join the online conference to join via a native application (e.g., Desktop/Windows/Mac/iOS/Android etc.) or via a website. These online conferencing solutions allow users to conduct meetings with audio, video, image, text, chat, etc. Some online conferencing solutions use an application or internet connection to provide rich experience features, such as chat, video, file sharing, or the like.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates an example system diagram for coordinating users into groups in an online meeting according to some examples of the present disclosure.

FIGS. 2-5 illustrate example user interfaces according to some examples of the present disclosure.

FIG. 6 illustrates a flowchart of a technique for coordinating users into groups in an online meeting according to some examples of the present disclosure.

FIG. 7 illustrates a block diagram of an example machine which may implement one or more of the techniques discussed herein according to some examples of the present disclosure.

### DETAILED DESCRIPTION

Systems and methods for coordinating users into groups in an online meeting are described herein. In an example, these systems and methods may be used to distinctly display attendees of the online meeting according to the groups. The groups may be identified based on tags of individuals in the online meeting. A tag may be applicable to an individual or a set of individuals in the online meeting. A tag may be generated based on one or more various attributes of an individual or the online meeting. For example, a tag may be based on an individual's job title, location, company, school, etc. A tag may be based on a role within the online meeting, such as presenter, host, attendee, group member, or the like. In some examples, the online meeting may be a video conferencing online meeting.

Individuals may be differentiated by groups using displayed representations that include at least one difference per group or in a manner that arranges members of groups in a visually distinct way. For example, groups may be highlighted or enclosed with different colors or shapes, groups may have borders or backgrounds that differ, groups may be located in different areas of a user interface, etc.

The systems and methods described herein provide technical improvements to user interfaces, such as those used for online meetings, including video conferencing online meetings. Specifically, technical advantages of the systems and methods described herein include combining participants for display in groups by attributes for easier participant organization inside meetings. Other technical advantages include improving speed for accessing group actions, such as muting or unmuting a group, sending a group to a breakout room, etc. An example technical problem includes limitations in grouping, displaying, or applying settings to a set of users in an online meeting. An example technical solution is described herein to solve the example technical problem, for example using tags to establish or maintain groups.

The systems and methods described herein are directed to a technical solution of displaying groups in an online meeting. Still further, technological solutions described herein provide visually distinct group display in an online meeting that improves access for those with visual or physical impairments that make navigating a user interface difficult. Improving ease of access of the user interface of an online meeting provides the technical solution for those users.

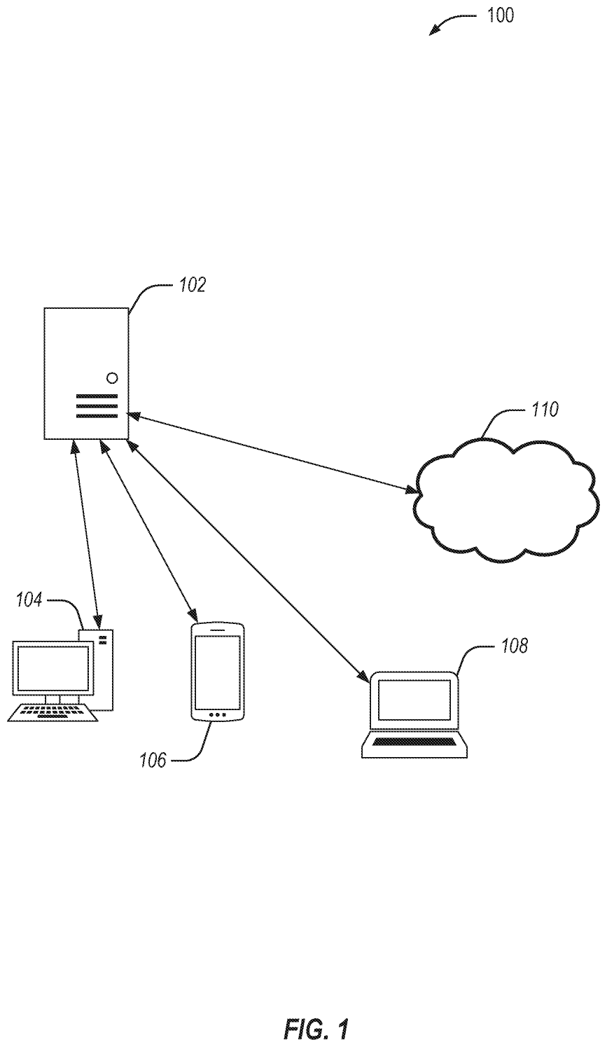

FIG. 1 illustrates an example system diagram 100 for coordinating users into groups in an online meeting according to some examples of the present disclosure. The diagram 100 illustrates an example connection setup, but may be modified with additional or fewer components. The diagram 100 includes a server 102 connected to one or more user devices (e.g., a desktop computer 104, a phone 106, a laptop 108, a tablet, etc.). The server 102 may be part of or in communication with the cloud 110.

The server 102 may host an online meeting by connecting participant devices (e.g., 104, 106, 108, etc.) using an audio connection, a client-based connection (e.g., a desktop app, a mobile app, a website, etc.), or the like. The server 102 may use a chat service, which may operate in the cloud 110, to manage a chat portion of the online meeting.

The server 102 or the cloud 110 may maintain or retrieve tags, group settings, or the like for an online meeting. In some examples, a user device may send or identify a tag or group setting to be used for an online meeting. The server 102 may configure the online meeting using tags or group settings retrieved or received (e.g., from the cloud 110, from the server 102, or from a user device). The online meeting may be instantiated with the configuration according to tags or group settings. In some examples, the tags or group settings for an online meeting may be modified during the online meeting, such as when an individual access the online meeting (e.g., enters the online meeting), In other examples, the online meeting may include static tags or group settings. When an online meeting ends, the server 102 or the cloud 110 may store tags or group settings generated or modified during the online meeting, or may discard changes as one time events.

When a user device connects to an online meeting, the server 102 may determine an appropriate tag or tags for the user and apply one or more group settings to a representation of the user device (which may include a representation of a user of the user device) within the online meeting. For example, the server 102 may place the representation in a particular component within a user interface of the online meeting according to the tag, or may modify a base version of the representation according to the tag (e.g., apply a border or background color, change a size, etc.).

The server 102 may distinctly display each group of members of an online meeting (e.g., visually separated or varying, such as in color, size, etc.). The distinct display of groups in the online meeting may be the same for each user device, or may vary based on group membership. For example, the server 102 may configure the online meeting to always include each user device's own group in a prominent position in the user interface (e.g., first in a list of groups), such that each user device in a group has a same or similar visual presentation, but user devices in different groups have different views.

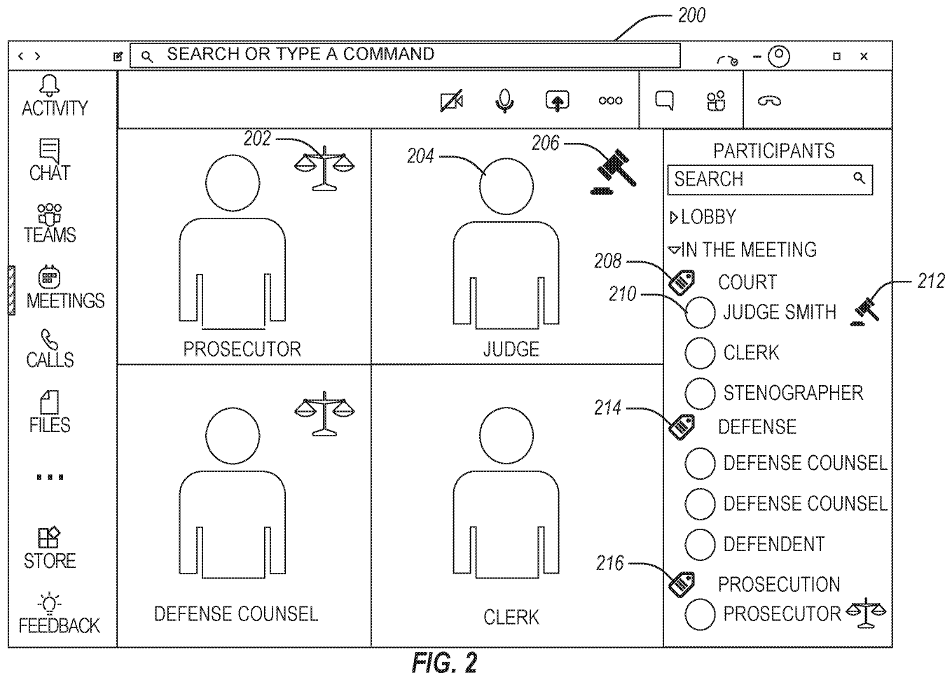

FIGS. 2-5 illustrate example user interfaces according to some examples of the present disclosure.

FIG. 2 illustrates an example user interface 200 with a court use case. The user interface 200 includes user interface components, such as video components and a participants component. The video components feature various users, who may be displaying an image, a video, a screen share, or the like. For example, the user interface 200 includes a prosecutor video component, a defense counsel video component, a clerk video component, and a judge video component. The judge video component features a judge 204, who may be visible to all participants, in an example.

The video components may include a visual identifier based on a tag or group of a particular user. For example, lawyers in the user interface 200 include a scale identifier (e.g., identifier 202 for the prosecutor). The judge may have a gavel identifier 206. In the example shown in user interface 200, some identifiers are used more than once (e.g., the scale for any attorney), while others may be used only for a single user (e.g., the gavel 206 for the judge 204). In addition to or instead of showing the indicators in the video components, the identifiers may be shown in the participants component.

Different privileges for shared content may be applied, such as depending on group membership. Particularly in persistent group membership or tags, shared content access or usage rights may be applied based on the group membership or tag. This may provide an easier process for applying shared content privileges, because the privileges may be made to the group rather than to each individual separately.

The participants component shows participants (not all participants are shown in the video components, which may optionally be for anonymity of a particular participant). The participants are grouped according to a tag. For example, members of the court are tagged with a court tag 208. The members of the court may include Judge Smith, who has an indicator 210 and a gavel identifier 212, a clerk (who may have a gavel identifier or some other court-administration type of identifier, such as where the gavel identifier 212 is specific to the judge only, or judges in general), or a stenographer. A defense team is represented under a defense tag 214, including defense counsel or a defendant. The prosecution is shown with a prosecution tag 216, including a prosecutor. While the example in FIG. 2 shows participants in a court hearing, the grouping, tags, identifiers, and components may be used with any type of online meeting, such as a business meeting, a client meeting, a school or classroom meeting, a friend group meeting, etc.

The user interface 200 may be used for members of an organization to be tagged and therefore carry one or more online badges, for example based on organization role or attribute of a member. The badges may be displayed (e.g., as an identifier) or allow grouping members (e.g., using the tags 208, 214, 216, for example) in an online meeting participant list. An organizer (e.g., in the example of FIG. 2, the clerk for example) may assign groups within the online meeting or manipulate groups as a whole. For example, the clerk may mute the defense or prosecution groups when the judge 204 is talking, disable video for jurors, or the like.

In other examples, such as in an education setting, a teacher may be an organizer or host, and assign students to different groups (e.g., “Student-7A,” “Spanish-101,” “Level 2,” “Shakespeare Project Group A,” etc.). For an enterprise scenario, groups may include “Sales Trainers,” “Sales,” “Singapore,” “John's directs,” “On call,” “IT help,” or the like, for example.

The group assignments may be used in various examples to manage large meetings (e.g., 1000 plus people), to provide seat assignments in a together mode (e.g., where cutouts of heads of participants are displayed as sitting together, such as in a meeting room, stadium seating, risers, etc.), or to assign groups to breakout rooms. The groups may be selected or used in meetings to control multiple users at the same time. Tags may be generated in any number of ways, such as manually by organizer (e.g., a private or a public tag that the organizer adds to identify a certain group), already existing tags from other sources (e.g., via email, organization chart, social media, location, etc.) or based on suggestion and selection, the suggestion based for example on a person's name card content, organization, location, and or attributes of a participant (e.g., an employee, a student, or the like).

When a conference system shares or streams content associated with specific metadata (such as #tag of “sales team”), the user interface 200 may automatically compose an attendee highlight frame by identifying attendees who are also associated with the #tag of the shared content. The highlight frame may go around the attendees with that tag (e.g., defense tag 214). In an example, the highlight frame may be shared by grouping and displaying the identified attendees at a designated display area, or by applying “highlighting” of the identified attendees (such as adding a frame or color to the identified attendees' videos or icons in the participants component).

In an example where a user interface such as user interface 200 is used in a classroom setting, groups or tags may include a teacher and students. Students may be assigned to project groups throughout a school year, and a tag may correspond to a project group. Tasks may be assigned to the group across meetings. During a meeting, the students may be shown according to their groups. In this example, the teacher may mute/unmute or allow video or screen sharing when a group is presenting. The teacher may view the groups across chat, search, or meeting rosters while the groups collaborate on their project. Project teams may be grouped for breakout rooms, be seated together, present on a virtual stage, access shared documents, assignments, or evaluations according to their tags. The groups may be individually created. In some examples, the groups may be visible only to the teacher (or other teachers), while in other examples, the groups may be visible to the students.

In an example where a user interface such as user interface 200 is used in a business setting, a lead role may be used by a moderator, a trainer, a boss, a manager, a director, etc. In this example, company teams may be grouped (e.g., sales team, human resources team, IT team, etc.). In some examples, the groups may include those that are employees of a company in one group and those who are not in another group (e.g., customers). In these examples, the employees may have a side chat without the customers, customers may be muted or prevented from sharing video or screens, or the like.

When content is shared in the user interface 200 (e.g., a document, such as a court brief or evidence, a school paper, a work document, a video, an image, a link, a chat comment, etc.), a group having a tag that corresponds with metadata (e.g., a metadata tag) of the shared content may be highlighted. Highlighting the group may include grouping the group together in the participants screen, grouping the group together in the video stream portion, adding a frame to members of the group, changing a background color of members of the group, displaying only the members of the group, or the like.

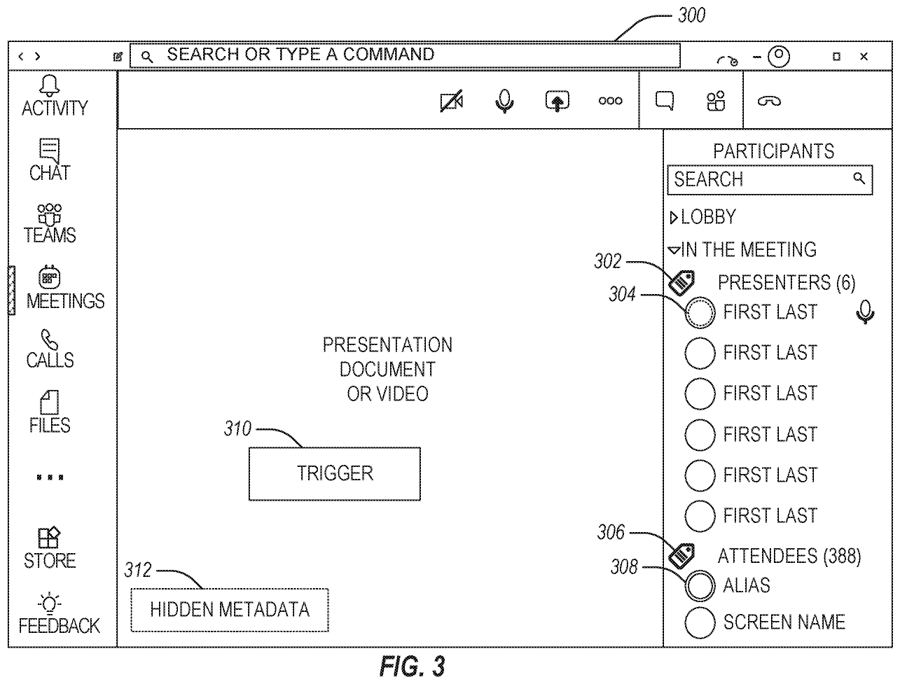

FIG. 3 illustrates a user interface 300 showing a presentation example. The presentation, which may include video, documents, screen sharing, etc., may have a presenter or set of presenters and attendees. In the example shown in FIG. 3, the presentation has six presenters, tagged with a presenters tag 302 and several hundred attendees, tagged with an attendees tag 306. These groupings allow the presenters or a moderator of the presentation to quickly identify which presenter is speaking or in control. For example, presenter 304 includes a visually distinct feature when presenting or speaking. Members of the presenters tag 302 group may always be displayed above the attendees. The attendees may have different attributes or parameters for the presentation than presenters. For example, the presenters tag 302 may include properties, such as starting the presentation unmated, with video, with ability to screen share, etc. The attendees tag 306 may include different properties, such as starting the presentation muted, prevented from unmuting, preventing video, preventing screen share, etc. The presenters may, in some examples, be able to modify attributes for attendees, while attendees may be prevented from modifying their own or the presenters attributes. The attendees tag 306 group may include a visual feature for person 308 such as when that person 308 has a question or comment.

The user interface 300 shows data corresponding to shared content (e.g., the presentation document or video), which may be used to determine metadata for identifying a tag associated with the shared content. The data may include a trigger 310, for example a visually displayed text, image, emoji, video, etc., which may be used to determine metadata corresponding to a tag. The data may include hidden metadata 312, which may be used as the metadata to identify a tag. In some examples, the shared content may include the trigger 310 or the hidden metadata 312, exclusively. In other examples, the shared content may include the trigger 310 and the hidden metadata 312. Metadata corresponding to a tag may be determined from the trigger 310, the hidden metadata 312, or both, depending on availability.

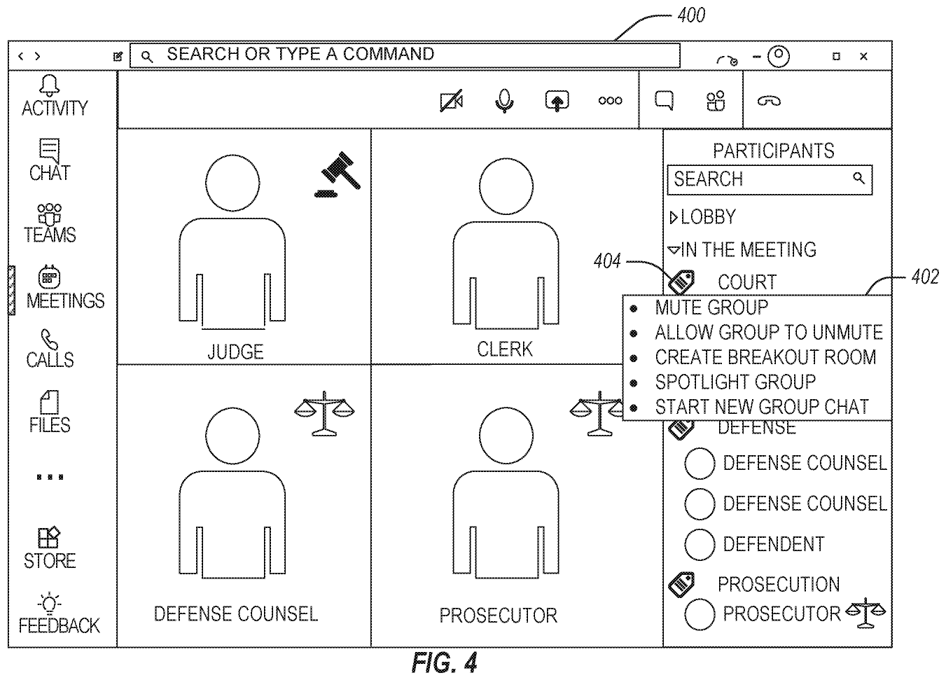

FIG. 4 illustrates a user interface 400 showing group controls. The user interface 400 includes a group control menu 402 for the court tag 404, which may be used to affect properties of members of the court tag 404 group (e.g., a judge, a clerk, etc.). Using the group control menu 402 may be reserved for a moderator, owner, organizer, or leader of a meeting (e.g., the clerk in a court setting, a moderator for a presentation, a teacher in a classroom, etc.). Some aspects of the group control menu 402 or different actions may be included for other users, in some examples, For example, different actions may be displayed and accessed in the group control menu 402 including organizer actions, presenter actions, attendee actions, in-group actions (e.g., within a user's own tag group), out-group actions (e.g., outside of a user's own tag group), administrator actions, etc.

The actions in the group control menu 402 include group actions that may be performed on the entire group, such as muting the group, allowing the group to unmute, creating a breakout room for the group, spotlighting the group (e.g., changing a visual aspect of the presentation of the group to highlight the group), starting a new group chat, or the like. The actions displayed in the group control menu 402 may differ depending not only on the user selecting the group control menu 402, but also which group is selected.

The tag may work as a badge like a “conference badge” in workshops to identify the user. In some examples, the tag group may be used to spotlight participants on the stage as a group for their videos to be highlighted as a group, create breakout room discussion groups to spread or group in a single room, automatically seat in a together mode, allow an organizer to mute or enable to unmute a group together, allow an organizer to assign polls or assignments to each group, search for or call in others into the meeting without searching for a specific name of a person, but by tag (e.g., invite IT department, invite HR department, invite all students, invite prosecutor group, etc.), allow teachers to send out assignments according to level, (e.g., level one gets assignment A, level 2 gets assignment B, etc.), or the like.

These action option may be provided to the organizer inside a people participant pane in an online meeting. An organizer in a webinar, or a large meeting setting may group people and manage them in groups throughout the meeting, and optionally after the meeting, such as in chat or assignment follow ups. The organizer may share documents with groups, or start new conversations with these tagged groups.

The user interface 400 includes an example rearrangement of video streams of attendees (e.g., as compared to the arrangement in the user interface 200 of FIG. 2). In this example, the user interface 400 includes the judge and the clerk video streams arranged on top of the screen, while other video streams are moved below. The judge and the clerk video streams may be recomposed based on a trigger, such as when content is shared. The shared content may include a document, such as a court decision, which is signed by the judge and the clerk, for example, or signed by the judge and shared by the clerk. Metadata determined from the shared content (e.g., determined from metadata in the shared content or determined based on displayed content) may be used to identify a “court” tag, which is associated with the judge and the clerk. In response to identifying the “court” tag, the user interface 400 may be recomposed to include the judge and the clerk video streams in a more prominent location, such as at the top of the screen. In some examples, instead of, or in addition to, rearranging the video streams, the video streams may be highlighted, flash one or more times, change background color, etc.

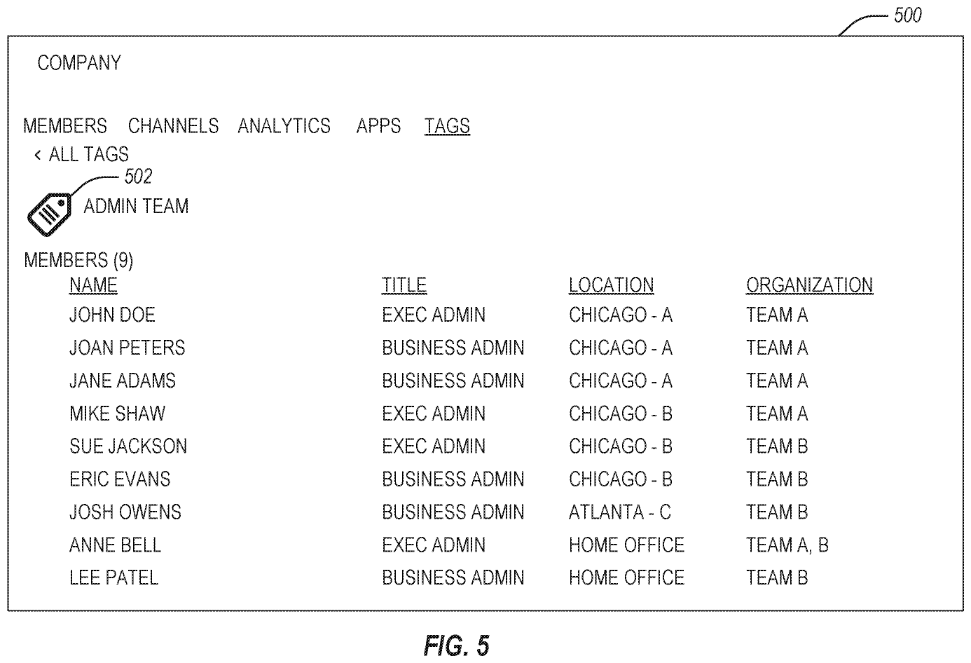

FIG. 5 illustrates a user interface 500 showing persistent tags. The persistent tags may, be used outside of meetings, such as for an organization chart, for group assignments, for an address book, etc. The persistent tags may be used to invite groups to an online meeting. The persistent tags may be used in the online meeting as described herein.

The persistent tags may include channel tags based on a user's job title, such as the admin team tag 502 in user interface 500. A user may have multiple tags. For example, the nine listed members in user interface 500 have the admin team tag 502, and users John Doe, Joan Peters, Jane Adams, Mike Shaw, Sue Jackson, and Eric Evans may all have a Chicago location tag. Within the Chicago location tag, there may be a sub-tag, such as a Chicago-A building tag and a Chicago-B building tag for the first three members and the fourth to sixth members, respectively. Job titles may be used for a tag, such as granularly (e.g., an exec admin or a business admin tag), or more broadly (e.g., employee, director, c-suite tags). An organization may create specific tags, such as Team A or Team B in user interface 500. These tags may be individually assigned, such as at time of hire. Temporary, but persistent tags may be used in some examples, such as a tag for a theme month, a tag for a set of meetings (e.g., a conference), or the like. Persistent in these examples is meant to connotate tags that are stored or used outside of a single meeting use. One-time tags for a meeting may be used, in the alternative to or in addition to persistent tags. An example one-time tag may include a team assigned within a meeting for breakout room purposes, without long-term meaning or purpose.

The admin team tag 502 is shown with group members of the tag. Tags may be searched, selected, or displayed. In some examples, multiple tags may be selected to display only members of all selected tags. For example, selecting the admin team tag 502 and a tag for Chicago-B location would result in only displaying Mike Shaw, Sue Jackson, and Eric Evans. Within the user interface 500, group actions may be applied to members of a group corresponding to the tag currently displayed. For example, the admin team may be invited to a meeting as a group. Tags may be created using the user interface 500, for example for an individual or for sets of members by selecting multiple members. Tags may be created in some examples (not shown in FIG. 5) with check boxes next to participants for creating groups or by dragging one user's name or icon on top of another person to create a group.

The tags (e.g., the admin team tag 502) may be generated from sources automatically, such as from an email address book, a contacts list, an organization chart, social media (e.g., job titles on a professional social media website), an enrollment or class list, user submitted data (e.g., wedding table assignments for a virtual wedding), location, distribution list, based on frequency of communication (e.g., a group that has meetings more than once may have a tag), public or private tags, or the like.

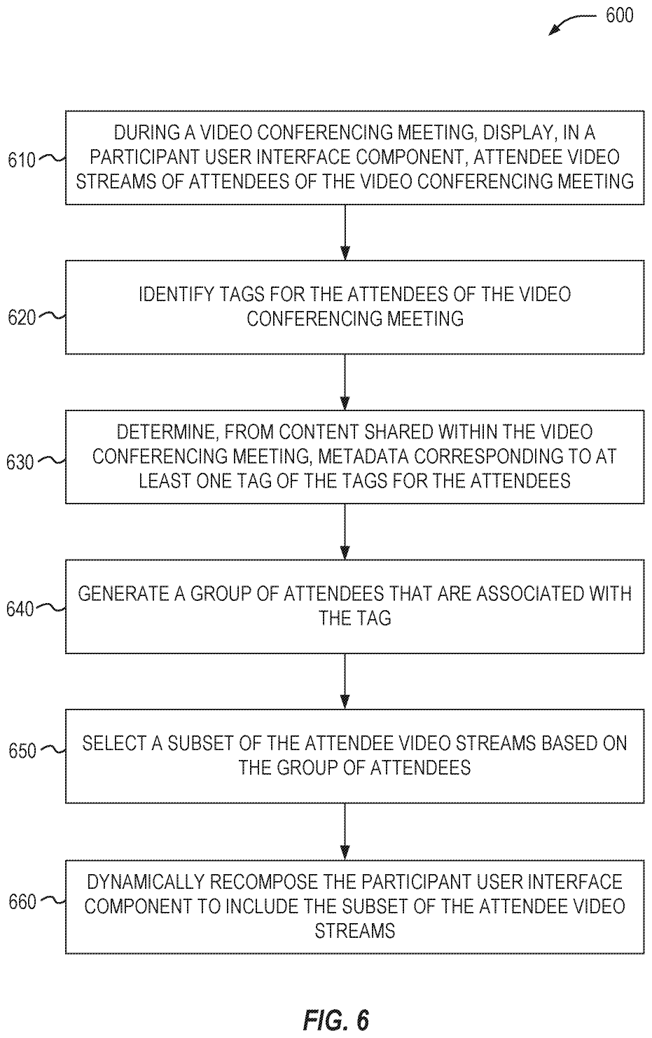

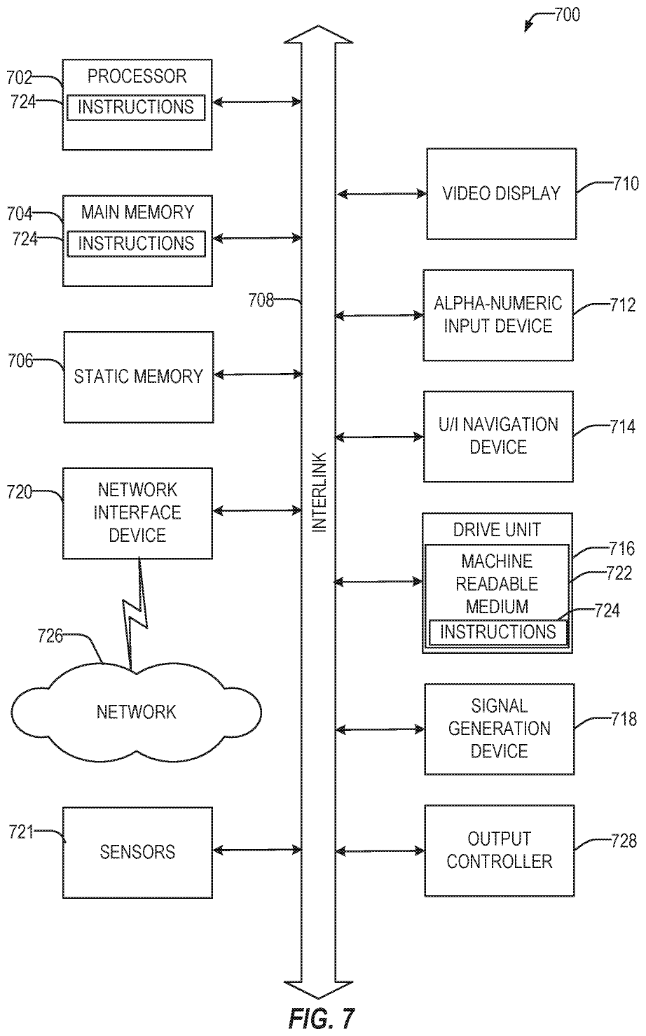

FIG. 6 illustrates a flowchart of a technique 600 for coordinating users into groups in an online meeting according to some examples of the present disclosure. The technique 600 may be performed using a processor or processors of a device, such as a computer, a laptop, a mobile device, or the like (e.g., as discussed in further detail with respect to FIG. 1 or 7). For example, the technique 600 may be performed by a presentation system, such as a user device (e.g., a phone, a laptop, a desktop computer, etc.) or a server.

The technique 600 includes an operation 610 to during a video conferencing meeting, display, in a participant user interface component, attendee video streams of attendees of the video conferencing meeting. The participant user interface component may display a subset of attendee video streams of attendees. The technique 600 includes an operation 620 to identify tags for the attendees of the video conferencing meeting. In an example, the tags are generated automatically from metadata of profiles associated with the attendees. The metadata may be in shared content (e.g., documents shared during a video conferencing meeting). In another example, the tags are generated by user selection based on suggestions provided automatically. The tags may include public tags, private tags, and tags unique to the attendees. For example, the tags may include public group identification (e.g., company, job title, etc.), private group identification (e.g., not shared outside an organization, such as team leader, location, etc.), or the like. Tags unique to an attendee may include unique job title or description, unique location (e.g., office 246), etc. In some examples the tags may be generated from social media profiles of the attendees.

In an example, the tags or the group of attendees are persistent for the attendees within an ecosystem, for example persisting after the video conferencing meeting has ended. The ecosystem may correspond to an employer, a school, or the like (e.g., a non-profit organization, a family, etc.). The attendees may be employees of the employer, students or the school, etc.

The technique 600 includes an operation 630 to determine, from content shared within the video conferencing meeting, metadata corresponding to at least one tag of the tags for the attendees. The content shared within the video conferencing meeting may include a document, a video, an image, a link, a message in a chat of the video conferencing meeting, or the like. The content shared may include a new page, component, or portion of a shared item, such as a document, video, etc. For example, during a presentation, a new slide may be shared, and an action (e.g., to recompose video streams) may be triggered based on metadata determined from the new slide. For example, “birthday” metadata may be determined based on text in the slide (e.g., using image processing, or a pixel analysis) wishing some set of attendees a happy birthday. The “birthday” metadata may correspond to a birthday tag, which may be used to recompose video streams corresponding to one or more attendees. In other examples, the metadata may be determined from document metadata (e.g., a slide note may indicate “birthday” or #birthday, for example).

Responsive to determining the metadata, the technique 600 may include performing operations 640, 650, or 660. The technique 600 includes an operation 640 to generate a group of attendees that are associated with the tag. Operation 640 may include using a user interface component via a user dragging at least one icon of a first attendee onto at least one icon of a second attendee within the user interface component of the video conferencing meeting. The technique 600 includes an operation 650 to select a subset of the attendee video streams based on the group of attendees. In some examples, the subset of the attendee video streams may include all attendee video streams or all attendee video streams corresponding to a group of attendees.

The technique 600 includes an operation 660 to dynamically recomposing the participant user interface component to include the subset of the attendee video streams. Operation 660 may include reorganizing the subset of the attendee video streams in a particular section of the participant user interface component, changing color of an icon corresponding to the group of attendees, changing an icon corresponding to the group of attendees, adding an icon next to an attendee avatar or icon, or highlighting or framing the subset of the attendee video streams.

The technique 600 may include receiving a video conferencing action corresponding to the group of attendees, the video conferencing action corresponding to a change to a video conferencing setting of the group of attendees. In this example, the technique 600 may include outputting, from the server, an indication including the video conferencing action for members of the group of attendees in the online video conferencing meeting. The action may include at least one of muting or unmuting all of the members of the group, assigning all of the members of the group to a breakout room, sharing a document with all of the members of the group, arranging seating for all of the members of the group in a together mode, or the like. The action may include assigning each group of the set of groups to a different breakout room.

FIG. 7 illustrates a block diagram of an example machine 700 which may implement one or more of the techniques (e.g., methodologies) discussed herein according to some examples of the present disclosure. In alternative embodiments, the machine 700 may operate as a standalone device or may be connected (e.g., networked) to other machines. In a networked deployment, the machine 700 may operate in the capacity of a server machine, a client machine, or both in server-client network environments. The machine 700 may be configured to perform the methods of FIG. 5 or 6. In an example, the machine 700 may act as a peer machine in peer-to-peer (P2P) (or other distributed) network environment. The machine 700 may be a user device, a remote device, a second remote device or other device which may take the form of a personal computer (PC), a tablet PC, a set-top box (STB), a personal digital assistant (PDA), a mobile telephone, a smart phone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms (hereinafter “modules”). Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

Machine (e.g., computer system) 700 may include a hardware processor 702 (e.g., a central processing unit (CPU), a graphics processing unit (GPU), a hardware processor core, or any combination thereof), a main memory 704 and a static memory 706, some or all of which may communicate with each other via an interlink (e.g., bus) 708. The machine 700 may further include a display unit 710, an alphanumeric input device 712 (e.g., a keyboard), and a user interface (UI) navigation device 714 (e.g., a mouse). In an example, the display unit 710, input device 712 and UI navigation device 714 may be a touch screen display. The machine 700 may additionally include a storage device (e.g., drive unit) 716, a signal generation device 718 (e.g., a speaker), a network interface device 720, and one or more sensors 721, such as a global positioning system (GPS) sensor, compass, accelerometer, or other sensor. The machine 700 may include an output controller 728, such as a serial (e.g., universal serial bus (USB)), parallel, or other wired or wireless (e.g., infrared (IR), near field communication (NEC), High-Definition Multimedia Interface (HDMI), etc.) connection to communicate or control one or more peripheral devices (e.g., a printer, card reader, etc.).

The storage device 716 may include a machine readable medium 722 on which is stored one or more sets of data structures or instructions 724 (e.g., software) embodying or utilized by any one or more of the techniques or functions described herein. The instructions 724 may also reside, completely or at least partially, within the main memory 704, within static memory 706, or within the hardware processor 702 during execution thereof by the machine 700. In an example, one or any combination of the hardware processor 702, the main memory 704, the static memory 706, or the storage device 716 may constitute machine readable media.

While the machine readable medium 722 is illustrated as a single medium, the term “machine readable medium” may include a single medium or multiple media (e.g., a centralized or distributed database, and/or associated caches and servers) configured to store the one or more instructions 724.

The term “machine readable medium” may include any medium that is capable of storing, encoding, or carrying instructions for execution by the machine 700 and that cause the machine 700 to perform any one or more of the techniques of the present disclosure, or that is capable of storing, encoding or carrying data structures used by or associated with such instructions. Non-limiting machine-readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); Solid State Drives (SSD); and CD-ROM and DVD-ROM disks. In some examples, machine readable media may be non-transitory machine-readable media. In some examples, machine readable media may include machine readable media that is not a transitory propagating signal.

The instructions 724 may further be transmitted or received over a communications network 726 using a transmission medium via the network interface device 720. The machine 700 may communicate with one or more other machines utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., institute of Electrical and Electronics Engineers (IEEE) 802.11 family of standards known as Wi-Fi®, WEE 802.16 family of standards known as WiMax®), IEEE 802.15.4 family of standards, a Long Term Evolution (LTE) family of standards, a Universal Mobile Telecommunications System (UMTS) family of standards, peer-to-peer (P2P) networks, among others. In an example, the network interface device 720 may include one or more physical jacks (e.g., Ethernet, coaxial, or phone jacks) or one or more antennas to connect to the communications network 726. In an example, the network interface device 720 may include a plurality of antennas to wirelessly communicate using at least one of single-input multiple-output (SIMO), multiple-input multiple-output (MEM), or multiple-input single-output (MISO) techniques. In some examples, the network interface device 720 may wirelessly communicate using Multiple User MIMO techniques.

Example 1 is a method for coordinating users into groups in an online meeting, the method comprising: during a video conferencing meeting, displaying, in a participant user interface component, attendee video streams of attendees of the video conferencing meeting; identifying tags for the attendees of the video conferencing meeting; determining, from content shared within the video conferencing meeting, metadata corresponding to at least one tag of the tags for the attendees; responsive to determining the metadata: generating, at a server, a group of attendees that are associated with the at least one tag; selecting a subset of the attendee video streams based on the group of attendees; and dynamically recomposing the participant user interface component to include, the subset of the attendee video streams.

In Example 2, the subject matter of Example 1 includes, wherein dynamically recomposing the subset of the attendee video streams includes reorganizing the subset of the attendee video streams in a particular section of the participant user interface component, changing a color of an icon corresponding to the group of attendees; changing an icon corresponding to the group of attendees, adding an icon next to an attendee avatar or icon, highlighting the subset of the attendee video streams, or framing the subset of the attendee video streams.

In Example 3, the subject matter of Examples 1-2 includes, receiving a video conferencing action corresponding to the group of attendees, the video conferencing action corresponding to a change to a video conferencing setting of the group of attendees; and outputting, from the server, an indication including the video conferencing action for members of the group of attendees in the online video conferencing meeting.

In Example 4, the subject matter of Example 3 includes, wherein the video conferencing action includes at least one of muting or unmuting the group of attendees; assigning the group of attendees to a breakout room, sharing a document with the group of attendees, or arranging seating for the group of attendees in a together mode.

In Example 5, the subject matter of Examples 1-4 includes, wherein the tags are generated automatically from metadata of profiles associated with the attendees or wherein the tags are generated from social media profiles of the attendees.

In Example 6, the subject matter of Examples 1-5 includes, wherein the tags are generated by user selection based on suggestions provided automatically.

In Example 7, the subject matter of Examples 1-6 includes, wherein the tags include public tags; private tags; and tags unique to the attendees.

In Example 8, the subject matter of Examples 1-7 includes, wherein the tags and the group of attendees are persistent for the attendees within an ecosystem, the tags and the group of attendees persisting after the video conferencing meeting has ended, and wherein the ecosystem corresponds to an employer or a school, the attendees being employees or students of the employer or the school; respectively.

In Example 9, the subject matter of Examples 1-8 includes, wherein the content shared within the video conferencing meeting includes a document or a message in a chat of the video conferencing meeting.

In Example 10, the subject matter of Examples 1-9 includes, wherein the group of attendees is generated using a user interface component via a user dragging at least one icon of a first attendee onto at least one icon of a second attendee within the user interface component of the video conferencing meeting.

Example 11 is a system for coordinating users into groups in an online meeting, the system comprising: a processor of a server; and memory of the server, the memory including instructions, which when executed by the processor, cause the processor to: during a video conferencing meeting, display, in a participant user interface component; attendee video streams of attendees of the video conferencing meeting; identify tags for the attendees of the video conferencing meeting; determine, from content shared within the video conferencing meeting, metadata corresponding to at least one tag of the tags for the attendees; responsive to determining the metadata: generate a group of attendees that are associated with the tag; select a subset of the attendee video streams based on the group of attendees; and dynamically recompose the participant user interface component to include, the subset of the attendee video streams.

In Example 12, the subject matter of Example 11 includes, wherein to dynamically recompose the subset of the attendee video streams; the instructions further cause the processor to reorganize the subset of the attendee video streams in a particular section of the participant user interface component, change color of an icon corresponding to the group of attendees, change an icon corresponding to the group of attendees, adding an icon next to an attendee avatar or icon, highlight the subset of the attendee video streams, or frame the subset of the attendee video streams.

In Example 13, the subject matter of Examples 11-12 includes, wherein the instructions further cause the processor to: receive a video conferencing action corresponding to the group of attendees, the video conferencing action corresponding to a change to a video conferencing setting of the group of attendees; and output, from the server, an indication including the video conferencing action for members of the group of attendees in the online video conferencing meeting.

In Example 14, the subject matter of Example 13 includes, wherein the video conferencing action includes at least one of muting or unmuting the group of attendees, assigning the group of attendees to a breakout room, sharing a document with the group of attendees, or arranging seating for the group of attendees in a together mode.

In Example 15, the subject matter of Examples 11-14 includes, wherein the tags are generated automatically from metadata of profiles associated with the attendees or wherein the tags are generated from social media profiles of the attendees.

In Example 16, the subject matter of Examples 11-15 includes, wherein the tags are generated by user selection based on suggestions provided automatically.

In Example 17, the subject matter of Examples 11-16 includes, wherein the tags include public tags, private tags, and tags unique to the attendees.

In Example 18, the subject matter of Examples 11-17 includes, wherein the content shared within the video conferencing meeting includes a document or a message in a chat of the video conferencing meeting.

In Example 19, the subject matter of Examples 11-18 includes, wherein the tags and the group of attendees are persistent for the attendees within an ecosystem, the tags and the group of attendees persisting after the video conferencing meeting has ended, and wherein the ecosystem corresponds to an employer or a school, the attendees being employees or students of the employer or the school, respectively.

Example 20 is an apparatus for coordinating users into groups in an online meeting, the apparatus comprising: means for during a video conferencing meeting, displaying, in a participant user interface component, attendee video streams of attendees of the video conferencing meeting; means for identifying tags for the attendees of the video conferencing meeting; means for determining, from content shared within the video conferencing meeting, metadata corresponding to at least one tag of the tags for the attendees; responsive to determining the metadata: means for generating, at a server; a group of attendees that are associated with the tag; means for selecting a subset of the attendee video streams based on the group of attendees; and means for dynamically recomposing the participant user interface component to include, the subset of the attendee video streams.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

What is claimed is:

1. A method for coordinating users into groups in an online meeting, the method comprising:
during a video conferencing meeting, displaying, in a participant user interface component, attendee video streams of attendees of the video conferencing meeting;
identifying tags for the attendees of the video conferencing meeting;
determining, from content shared within the video conferencing meeting, metadata corresponding to at least one tag of the tags for the attendees;
responsive to determining the metadata:
generating, at a server, a group of attendees that are associated with the at least one tag;
selecting a subset of the attendee video streams based on the group of attendees; and
dynamically recomposing the participant user interface component to include the subset of the attendee video streams.

2. The method of claim 1, wherein dynamically recomposing the subset of the attendee video streams includes reorganizing the subset of the attendee video streams in a particular section of the participant user interface component, changing a color of an icon corresponding to the group of attendees, changing an icon corresponding to the group of attendees, adding an icon next to an attendee avatar or icon, highlighting the subset of the attendee video streams, or framing the subset of the attendee video streams.

2. The method of claim 1, further comprising:
receiving a video conferencing action corresponding to the group of attendees, the video conferencing action corresponding to a change to a video conferencing setting of the group of attendees; and
outputting, from the server, an indication including the video conferencing action for members of the group of attendees in the online video conferencing meeting.

4. The method of claim 3, wherein the video conferencing action includes at least one of muting or unmuting the group of attendees, assigning the group of attendees to a breakout room, sharing a document with the group of attendees, or arranging seating for the group of attendees in a together mode.

5. The method of claim 1, wherein the tags are generated automatically from metadata of profiles associated with the attendees or wherein the tags are generated from social media profiles of the attendees.

6. The method of claim 1, wherein h tags are generated by user selection based on suggestions provided automatically. The method of claim 1, wherein the tags include public tags, private tags, and tags unique to the attendees.

8. The method of claim 1, wherein the tags and the group of attendees are persistent for the attendees within an ecosystem, the tags and the group of attendees persisting after the video conferencing meeting has ended, and wherein the ecosystem corresponds to an employer or a school, the attendees being employees or students of the employer or the school, respectively.

9. The method of claim 1, wherein the content shared within the video conferencing meeting includes a document or a message in a chat of the video conferencing meeting.

10. The method of claim 1, wherein the group of attendees is generated using a user interface component via a user dragging at least one icon of a first attendee onto at least one icon of a second attendee within the user interface component of the video conferencing meeting.

11. A system for coordinating users into groups in an online meeting, the system comprising:
a processor of a server; and
memory of the server, the memory including instructions, which when executed by the processor, cause the processor to:
during a video conferencing meeting, display, in a participant user interface component, attendee video streams of attendees of the video conferencing meeting;
identify tags for the attendees of the video conferencing meeting;
determine, from content shared within the video conferencing meeting, metadata corresponding to at least one tag of the tags for the attendees;
responsive to determining the metadata:
generate a group of attendees that are associated with the tag;
select a subset of the attendee video streams based on the group of attendees; and
dynamically recompose the participant user interface component to include the subset of the attendee video streams.

12. The system of claim 11, wherein to dynamically recompose the subset of the attendee video streams, the instructions further cause the processor to reorganize the subset of the attendee video streams in a particular section of the participant user interface component, change color of an icon corresponding to the group of attendees, change an icon corresponding to the group of attendees, adding an icon next to an attendee avatar or icon, highlight the subset of the attendee video streams, or frame the subset of the attendee video streams.

13. The system of claim 11, wherein the instructions further cause the processor to:
receive a video conferencing action corresponding to the group of attendees, the video conferencing action corresponding to a change to a video conferencing setting of the group of attendees; and
output, from the server, an indication including the video conferencing action for members of the group of attendees in the online video conferencing meeting.

14. The system of claim 13, wherein the video conferencing action includes at least one of muting or unmuting the group of attendees, assigning the group of attendees to a breakout room, sharing a document with the group of attendees, or arranging seating for the group of attendees in a together mode.

15. The system of claim 11, wherein the tags are generated automatically from metadata of profiles associated with the attendees or wherein the tags are generated from social media profiles of the attendees.

16. The system of claim 11, wherein the tags are generated by user selection based on suggestions provided automatically.

17. The system of claim 11, wherein the tags include public tags, private tags, and tags unique to the attendees.

18. The system of claim 11, wherein the content shared within the video conferencing meeting includes a document or a message in a chat of the video conferencing meeting.

19. The system of claim 11, wherein the tags and the group of attendees are persistent for the attendees within an ecosystem, the tags and the group of attendees persisting after the video conferencing meeting has ended, and wherein the ecosystem corresponds to an employer or a school, the attendees being employees or students of the employer or the school, respectively.

20. An apparatus for coordinating users into groups in an online meeting, the apparatus comprising:
means for during a video conferencing meeting, displaying, in a participant user interface component, attendee video streams of attendees of the video conferencing meeting;
means for identifying tags for the attendees of the video conferencing meeting;
means for determining, from content shared within the video conferencing meeting, metadata corresponding to at least one tag of the tags for the attendees;
responsive to determining the metadata:
means for generating, at a server, a group of attendees that are associated with the tag;
means for selecting a subset of the attendee video streams based on the group of attendees; and
means for dynamically recomposing the participant user interface component to include the subset of the attendee video streams.
